(19) United States
(12) Patent Application Publication
(10) Pub. No.: US 2013/0309041 A1
(43) Pub. Date: Nov. 21, 2013

(54) LOCK NUT FASTENING SYSTEM

(71) Applicants: Eduard Grigoryan, Sylmar, CA (US); Artur Sarkisyants, Sylmar, CA (US)

(72) Inventors: Eduard Grigoryan, Sylmar, CA (US); Artur Sarkisyants, Sylmar, CA (US)

(21) Appl. No.: 13/855,680

(22) Filed: Apr. 2, 2013

Related U.S. Application Data
(60) Provisional application No. 61/686,217, filed on Apr. 2, 2012.

(51) Int. Cl. F16B 39/12

(52) U.S. Cl. CPC F16B 39/12
USPC 411/204

(57) ABSTRACT

The invention provides a locking fastener that replaces conventional hex nuts in construction applications where hex nuts are used as fasteners with all thread steel rods. The Lock Nut is a square, or rectangular box having an aperture in the center of one end to accommodate a screw. The screw turns a stationary worm gear which engages a nut which raises or lowers the all thread rod.

### CLAIM OF PRIORITY

This patent application claims priority under 35 USC 119 (e) (1) from U.S. Provisional Patent Application Ser. No. 61/686,217 filed Apr. 2, 2012, of common inventorship herewith entitled, “Lock Nuts.”

### FIELD OF THE INVENTION

The present invention pertains to the field of construction and manufacturing, and more specifically to the field of locking fastener assemblies.

### BACKGROUND OF THE INVENTION

The prior art has put forth several designs for locking fastener assemblies. Among these are:

U.S. Pat. No. 5,746,558 to William D. Nygren, Jr. and Arwen G. Isaar describes a locking apparatus for limiting displacement of a fastener relative to first and second members interconnected thereby. The locking apparatus includes a locking member which is insertable within a first bore of the first member. The locking member has an elastically deformable upper portion and a leg which extend between the fastener and the first member to substantially inhibit rotational displacement of the fastener relative to the first member.

U.S. Pat. No. 5,964,559 to Stephen W. Larimore and Kenny J. Hanzlick describes a locking assembly that mechanically locks an attachment bolt such as one used to secure a missile launcher to an aircraft. This locking assembly prevents a bolt from vibrating loose as a result of vibration experienced during flight. The locking assembly has a spring loaded locking nut that mechanically engages a hex head of an extension shaft that is coupled to the attachment bolt. Transverse pins permit axial movement of the locking nut but prevent rotation thereof. A socket is used to push the locking nut away from the hex head of the extension shaft, so the attachment bolt can be loosened or tightened. When the socket is removed, a spring pushes the locking nut over the hex head of the extension shaft, locking the attachment bolt and preventing it from turning.

U.S. Pat. No. 6,679,663 to Robert J. DiStasio, Stephen G. Bowling, Carl Richard Stanley, David Ruyl Luster, Irwin I. Silberman and William Kurt Feick describes locking nut, bolt and clip systems and assemblies. The locking nut and bolt system utilizes a bolt with thread having a plurality of notches generally longitudinally spaced in a predetermined pattern. Each notch has a lock face and an opposing slope. The locking unit carries one or more tines. The tine has a distal tine end adapted to latch on to the lock face of the notch on the bolt. The locking unit supports the tine and may be cylindrical, rectangular or on a perpendicular support face normal to a radial plane through the axial centerline of the nut thread. The locking unit is on a nut insert, is carried on a leg of a U, J or S shaped clip, and is recessed as a blind hole.

None of these prior art references describe the present invention.

### SUMMARY OF THE INVENTION

It is an object of the present invention to provide a device comprising a reliable locking nut system wherein the device is installable to and removable from an all thread rod by using a power drill.

### BRIEF DESCRIPTION OF THE DRAWINGS

FIG. 1 is an illustrative view showing a drill with a hex drive and a close up view of a U Channel.

FIG. 2 is an illustrative view of a drill and a screwing mechanism with a head, springs to eliminate a stopper when pushed, a threaded rod and a stopper thread.

FIG. 3 is an illustrative functional view showing a threaded rod, concrete, a concrete anchor, lock nuts, motorized equipment and a Unistrut™ channel, showing one application of the present invention.

FIG. 4 is a diagrammatic perspective illustration of the all-thread rod travelling vertically through the inner components of the present invention.

FIG. 5 is a diagrammatic cut away elevational perspective illustration of the entire present invention showing its components in phantom.

FIG. 6 is a front perspective view of the present invention showing the hex nut and its operation.

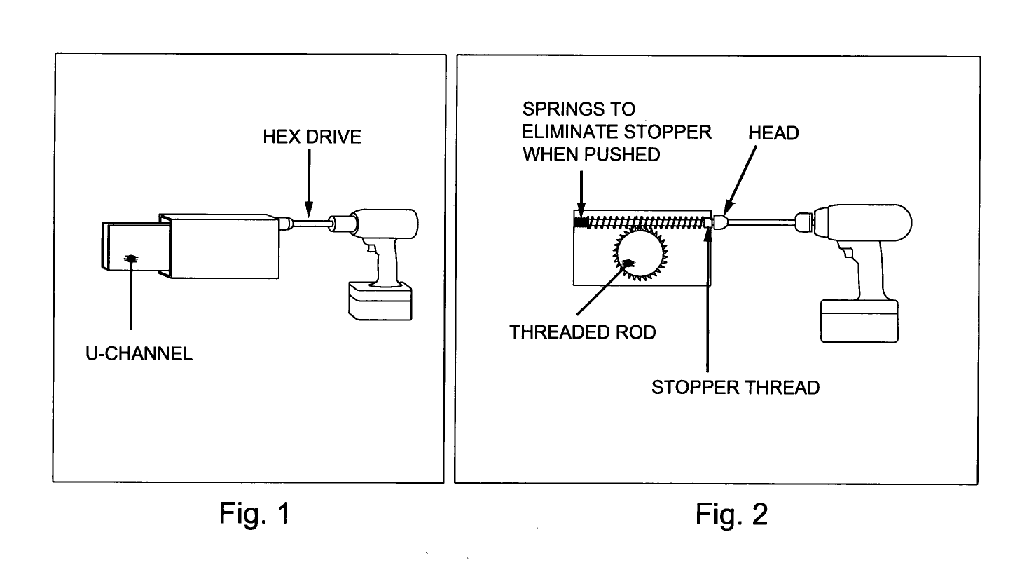

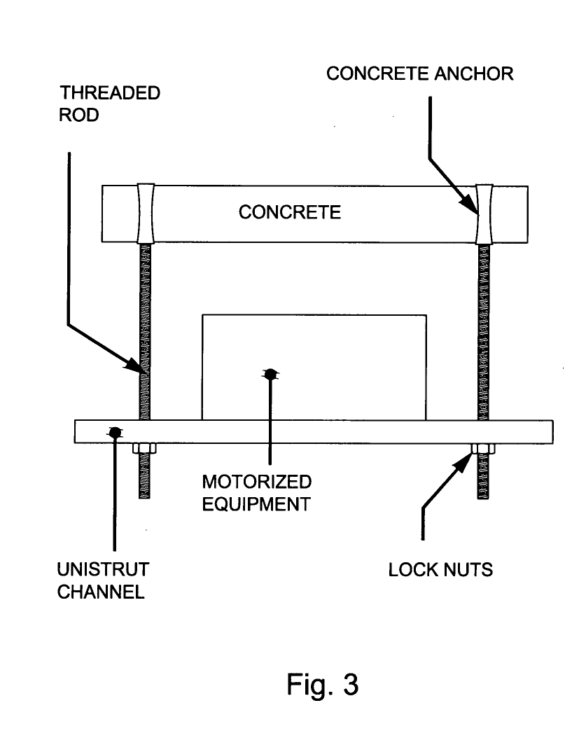

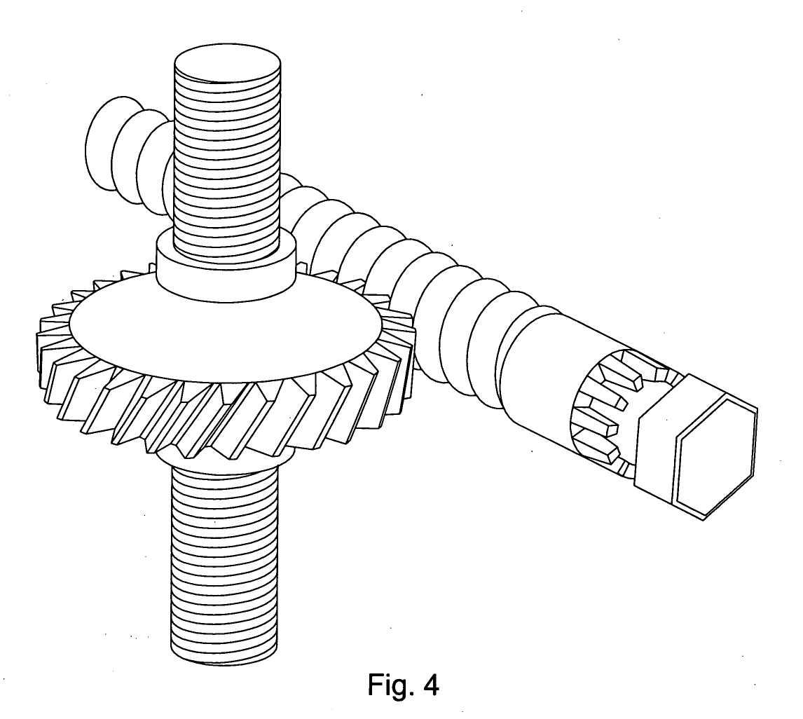

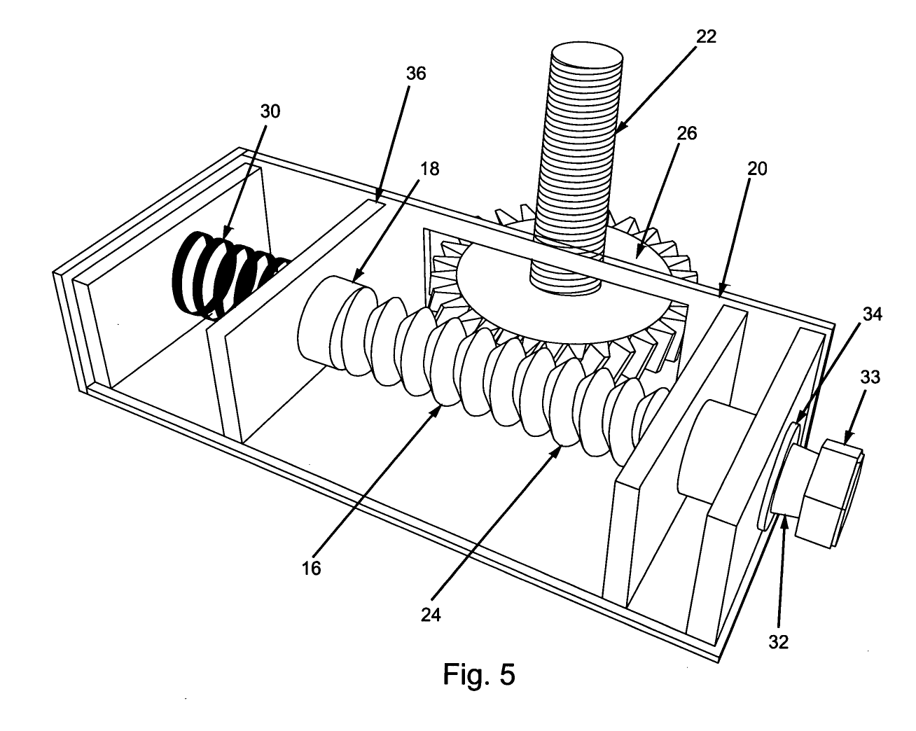

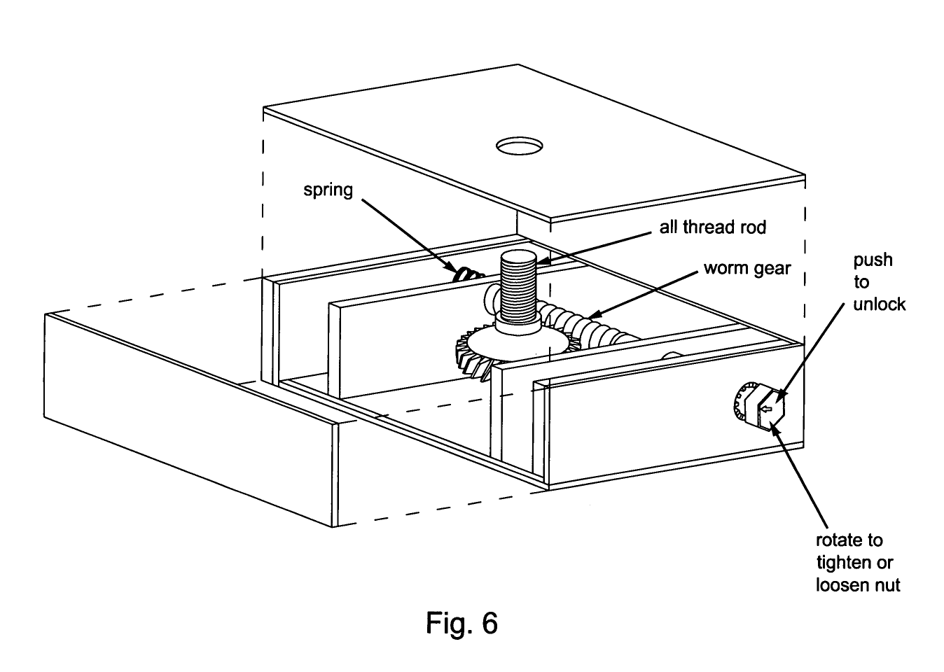

### DETAILED DESCRIPTION OF THE INVENTION

Bolts are solid machine threaded shafts of metal that are employed as fasteners in everything from automobile and aircraft engines to backyard decks and swing sets. Nuts and bolts literally prevent the modern industrialized world from falling apart. Getting to the nuts and bolts is an often used speaking phrase that infers getting down something's actual workings, hardware or essence, and to the heart of the matter. Bolts were invented to hold two things tightly together and over time have evolved into a dizzying array of hex bolts, carriage bolts, lag bolts, socket bolts, tap bolts, all thread bolts and rods. Depending on their use, bolts are manufactured in a wide variety of metals from zinc plated low carbon steel to silicon bronze and stainless steel. Some bolts join two things together such as an alternator and an engine block by means of a threaded nut that climbs toward the head of the bolt when tightened and binds the two items between the head of the bolt and the nut as though in a vise. Other baits such as the oil drain plug at the bottom of a car engine are fastened directly into threads machined into the object itself and require no fastening nut. Depending upon their usage, bolts comprise a wide variety of head configurations. Hex bolts have a six sided head to accommodate a wrench's jaws or socket. Carriage bolts have a smooth head and are tightened by a nut rather than a bolt head. These bolts and nut configurations often lack in technical perfection. The hex nuts used to secure all thread steel rods must be tightened with a manual wrench. If an all thread rod extends several inches and more beyond the level of a nut, an efficient socket wrench is unusable. Even when tightened to desired levels, standard hex nuts are loosened by subsequent vibration of supported machinery.

The present invention, hereinafter referred to as Lock Nuts, is a locking fastener that replaces conventional hex nuts in construction applications where hex nuts are used as fasteners with all thread steel rods. The unique design of Lock Nuts eliminates the need for a manual wrench when installing and removing fasteners, instead permitting installation and removal with a hex drive and power impact drill. Lock Nuts work in conjunction with a power impact drill equipped with an approximately five sixteenths inch hex drive head to securely lock in place upon installation. A Lock Nut is designed to be used with a one half inch all thread steel rod, principally in applications where this all thread rod is used to support channel systems such as Unistrut™.

The configuration of a Lock Nut is quite different from the configuration of a simple threaded hex style nut or a spring nut often used with the Unistrut system. Unlike a conventional hexnut, the Lock Nut is a square, or rectangular box having an aperture 34 in the center of one end to accommodate a screw 32. The square or rectangular casing may be made of any suitable material, such heavy duty, high tensile strength plastic or silicone, or steel, or other metal, for example. If the casing 20 is square, the casing measures one to and one and one half inches on each side, and approximately one half in height.

Where a conventional threaded hex nut is simply threaded and rotated on and along the threads of the all thread rod or bolt for tightening, the Lock Nut fastens by a dramatically different means. A stationary worm gear 16, or Archimedean screw rests inside a cylindrical tube 18 in the casing 20. The cylindrical tube 18 supports the worm gear 16. A stationary worm gear 16, or Archimedean screw is supported by a cylindrical tube 18 in the casing 20. The cylindrical tube 18 runs inside the casing from the screw 32 up to stopper 26.

The cylindrical tube 18 has an opening in one side to permit engagement of nut 26 with the worm gear 16. Worm gear 16 is set at a right angle to the axis of the all thread rod 22. The worm gear 16 is equipped with threads or ridges 24, which ridges 24 engage the corresponding ridge of the nut 26. When nut 26 rotates, the all thread rod is raised or lowered.

The proximal end of this screw 32 is fitted with an approximately five sixteenths inch hex head 33 and a stopper thread. The distal end terminates in a coil 30 that springs to eliminate the stopper 36 when pushed. Using a power impact drill, the Archimedean screw 16 is pushed inward to engage the corresponding ridges in the nut 26, thereby raising or lowering the all thread rod 22, moving the Lock Nut 26 into a desired position. When this position is reached, the Lock Nut 26 is tightened by turning screw 32 in a clockwise direction, then releasing pressure of the hex drive drill head results in a repositioning of the internal screw which in turn activates a secure locking action. This secure locked position is reversed and unlocked only by removal of the nut with the hex headed impact drill set in reverse motion.

Lock Nuts enable workers to quickly, easily and securely lock steel channels in place with a fastener that is applied and tightened to an all thread steel rod within moments using a power impact drill. Far easier to install than a conventional hex nut and delivering a superior locking mode of fastening, Lock Nuts are far more reliable than spring nuts where vibration of supported machinery is a concern. Durable, affordable and time saving in application, Lock Nuts will withstand years of continued use in various trades of the construction industry.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A reliable locking nut system installable to and removable from an all thread rod by using a power drill, comprising:
a casing comprising square, or rectangular box having an aperture in the center of one end to accommodate a screw, further comprising a screw, a worm gear, a cylindrical tube, a stopper, a spring, a nut, wherein the screw engages the worm gear which worm gear turns the nut, which nut raises and lowers an all thread rod; wherein the cylindrical tube supports the worm gear, and wherein the worm gear is set at a right angle to the axis of the all thread rod and further wherein the worm gear is equipped with ridges, which ridges engage corresponding ridges in the nut, further wherein the screw has a distal end and a proximal end and wherein the proximal end of the screw is fitted with a hex head and a stopper thread ands wherein the distal end of the screw terminates in a spring which eliminates a stopper when the spring is pushed.

2. The reliable locking nut system of claim 1 wherein the casing comprises heavy duty, high tensile strength plastic or silicone, or steel, or other metal.

3. The reliable locking nut system of claim 1 configured to accommodate for one half inch diameter all thread rod.
